(19) United States
(12) Patent Application Publication
(10) Pub. No.: US 2024/0212163 A1
(43) Pub. Date: Jun. 27, 2024

(54) SYSTEMS AND METHODS FOR IMAGE SEGMENTATION

(71) Applicant: SHANGHAI UNITED IMAGING HEALTHCARE CO., LTD., Shanghai (CN)

(72) Inventors: Le YANG, Shanghai (CN); Yang HU, Shanghai (CN); Na ZHANG, Shanghai (CN)

(73) Assignee: SHANGHAI UNITED IMAGING HEALTHCARE CO., LTD., Shanghai (CN)

(21) Appl. No.: 18/596,681

(22) Filed: Mar. 6, 2024

Related U.S. Application Data
(63) Continuation of application No. PCT/CN2022/121628, filed on Sep. 27, 2022.

(30) Foreign Application Priority Data
Sep. 27, 2021 (CN) 202111138085.6

(51) Int. Cl. G06T 7/12; G06T 5/20; G06T 7/00; G06T 7/13

(52) U.S. Cl. CPC G06T 7/12; G06T 5/20; G06T 7/0012; G06T 7/13; G06T 2207/10081; G06T 2207/20081; G06T 2207/30068

(57) ABSTRACT

The present disclosure provides systems and methods for image segmentation. The method may include determining, based on image data of a subject, an initial boundary of a target object inside the subject, wherein a difference between a first parameter value of at least one parameter of the target object and a second parameter value of the at least one parameter of the subject satisfies a condition; determining, based on the initial boundary of the target object, a closed boundary of the target object; and segmenting, based on the initial boundary and the closed boundary, a target portion corresponding to the target object from the image data.

### CROSS-REFERENCE TO RELATED APPLICATIONS

This application is a Continuation of International Application No. PCT/CN2022/121628 filed on Sep. 27, 2022, which claims priority to Chinese Patent Application No. 202111138085.6, filed on Sep. 27, 2021, the contents of which are incorporated herein by reference.

### TECHNICAL FIELD

The present disclosure generally relates to image processing, and more particularly, relates to systems and methods for image segmentation.

### BACKGROUND

Medical imaging techniques (e.g., X-ray, magnetic resonance imaging (MRI), computed tomography (CT), etc.) have been widely used in a variety of fields including, e.g., medical treatments and/or diagnosis. However, since the scanning subjects (e.g., a body part of a patient) are often associated with or contain one or more attenuation objects (e.g., calcifications, metal implants, needles), images reconstructed based on the medical imaging techniques can include artifact(s), thereby reducing the accuracy of the images and the diagnosis based on the images. Therefore, it is desirable to provide systems and methods for image segmentation, which can efficiently reduce or eliminate the artifact(s) in the reconstructed image and improve image quality.

### SUMMARY

In one aspect of the present disclosure, a method for image segmentation is provided. The method may be implemented on a computing device having at least one processor and at least one storage device. The method may include determining, based on image data of a subject, an initial boundary of a target object inside the subject. A difference between a first parameter value of at least one parameter of the target object and a second parameter value of the at least one parameter of the subject may satisfy a condition. The method may include determining, based on the initial boundary of the target object, a closed boundary of the target object. The method may further include segmenting, based on the initial boundary and the closed boundary, a target portion corresponding to the target object from the image data.

In some embodiments, the determining, based on the initial boundary of the target object, a closed boundary of the target object may include identifying a plurality of points on the initial boundary of the target object; generating a closed region by connecting each two points among the plurality of points; and determining, based on the closed region, the closed boundary of the target object.

In some embodiments, the segmenting, based on the initial boundary and the closed boundary, a target portion corresponding to the target object from the image data may include determining, based on the initial boundary and the closed boundary, a target boundary of the target object; and segmenting, based on the target boundary, the target portion corresponding to the target region from the image data.

In some embodiments, the determining, based on the initial boundary and the closed boundary, a target boundary of the target object may include generating a union of the initial boundary and the closed boundary; and determining the target boundary of the target object by processing the union of the initial boundary and the closed boundary.

In some embodiments, the at least one parameter may include at least one of an attenuation parameter or a gradient parameter.

In some embodiments, the determining, based on image data of a subject, an initial boundary of a target object inside the subject may include segmenting an initial portion including the target object from the image data; and identifying, based on the initial portion, the initial boundary of the target object.

In some embodiments, the image data may include at least one of projection data, a gradient image, at least one tomographic image, or a reconstruction image.

In some embodiments, the method may further include correcting the image data of the subject by obtaining a corrected target portion by correcting the target portion corresponding to the target object; and correcting the image data of the subject based on the image data and the correct target region.

In some embodiments, the correcting the image data of the subject based on the image data and the correct target region may include obtaining remaining image data by deleting the target portion corresponding to the target object from the image data; and correcting the image data of the subject based on the remaining image data and the correct target region.

In another aspect of the present disclosure, a method for image segmentation is provided. The method may be implemented on a computing device having at least one processor and at least one storage device. The method may include obtaining image data of a subject, the subject including a target object. A difference between a first parameter value of at least one parameter of the target object and a second parameter value of the at least one parameter of the subject may satisfy a condition. The method may include determining, based on the image data, an initial portion including the target object. The method may further include segmenting a target portion corresponding to the target object from the initial portion.

In some embodiments, the segmenting a target portion corresponding to the target object from the initial portion may include obtaining an image segmentation model; and determining the target portion corresponding to the target object by inputting the initial portion into the image segmentation model.

In some embodiments, the segmenting a target portion corresponding to the target object from the initial portion may include determining, based on the initial portion, an initial boundary of the target object inside the subject; determining, based on the initial boundary of the target object, a closed boundary of the target object; and segmenting, based on the initial boundary and the closed boundary, the target portion corresponding to the target object from the initial portion.

In some embodiments, the determining, based on the initial boundary of the target object, a closed boundary of the target object may include identifying a plurality of points on the initial boundary of the target object; generating a closed region by connecting each two points among the plurality of points; and determining, based on the closed region, the closed boundary of the target object.

In some embodiments, the segmenting, based on the initial boundary and the closed boundary, the target portion corresponding to the target object from the initial portion may include determining, based on the initial boundary and the closed boundary, a target boundary of the target object; and segmenting, based on the target boundary, the target portion corresponding to the target region from the initial portion.

In some embodiments, the determining, based on the initial boundary and the closed boundary, a target boundary of the target object may include generating a union of the initial boundary and the closed boundary; and determining the target boundary of the target object by processing the union of the initial boundary and the closed boundary.

In some embodiments, the at least one parameter may include at least one of an attenuation parameter or a gradient parameter.

In some embodiments, the determining, based on the initial portion, an initial boundary of the target object inside the subject may include segmenting the initial portion including the target object from the image data; and identifying, based on the initial portion, the initial boundary of the target object.

In some embodiments, the method may further include correcting the image data of the subject by obtaining a corrected target portion by correcting the target portion corresponding to the target object; and correcting the image data of the subject based on the image data and the correct target region.

In some embodiments, the correcting the image data of the subject based on the image data and the correct target region may include obtaining remaining image data by deleting the target portion corresponding to the target object from the image data; and correcting the image data of the subject based on the remaining image data and the correct target region.

In still another aspect of the present disclosure, a method for image correction is provided. The method may be implemented on a computing device having at least one processor and at least one storage device. The method may include obtaining image data of a subject, the subject including a target object. A difference between a first parameter value of at least one parameter of the target object and a second parameter value of the at least one parameter of the subject may satisfy a condition. The method may include determining, based on the image data, an initial portion including the target object. The method may include segmenting a target portion corresponding to the target object from the initial portion. The method may further include correcting the image data of the subject based on the target portion corresponding to the target object.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a block diagram illustrating an exemplary processing device according to some embodiments of the present disclosure;

FIG. 3 is a flowchart illustrating an exemplary process for image correction according to some embodiments of the present disclosure;

FIG. 4 is a flowchart illustrating an exemplary process for determining an initial boundary of a target object inside a subject according to some embodiments of the present disclosure;

FIG. 5 is a schematic diagram illustrating an exemplary initial portion in a gradient image according to some embodiments of the present disclosure;

FIG. 6 is a schematic diagram illustrating an exemplary process for identifying an initial boundary of a target object according to some embodiments of the present disclosure;

FIG. 7 is a schematic diagram illustrating an exemplary closed boundary of a target object according to some embodiments of the present disclosure;

FIG. 8 is a schematic diagram illustrating an exemplary target boundary of a target object according to some embodiments of the present disclosure;

FIG. 9 is a schematic diagram illustrating an exemplary process for determining a target portion according to some embodiments of the present disclosure; and

FIG. 10 is a diagram illustrating an exemplary computing device according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

In the present disclosure, the term “image” may refer to a two-dimensional (2D) image, a three-dimensional (3D) image, or a four-dimensional (4D) image (e.g., a time series of 3D images). In some embodiments, the term “image” may refer to an image of a region (e.g., a region of interest (ROI)) of a subject. In some embodiment, the image may be a medical image, an optical image, etc.

In the present disclosure, a representation of a subject (e.g., an object, a patient, or a portion thereof) in an image may be referred to as “subject” for brevity. For instance, a representation of an organ, tissue (e.g., a heart, a liver, a lung), or an ROI in an image may be referred to as the organ, tissue, or ROI, for brevity. Further, an image including a representation of a subject, or a portion thereof, may be referred to as an image of the subject, or a portion thereof, or an image including the subject, or a portion thereof, for brevity. Still further, an operation performed on a representation of a subject, or a portion thereof, in an image may be referred to as an operation performed on the subject, or a portion thereof, for brevity. For instance, a segmentation of a portion of an image including a representation of an ROI from the image may be referred to as a segmentation of the ROI for brevity.

The present disclosure relates to systems and methods for image segmentation. The method may include determining, based on image data of a subject, an initial boundary of a target object inside the subject. A difference between a first parameter value of at least one parameter of the target object and a second parameter value of the at least one parameter of the subject may satisfy a condition. The method may include determining, based on the initial boundary of the target object, a closed boundary of the target object. Further, the method may include segmenting, based on the initial boundary and the closed boundary, a target portion corresponding to the target object from the image data. Though the initial boundary and the closed boundary, a target boundary (i.e., a precise boundary) of the target object in the image data may be determined, which can improve the accuracy of the segmentation of the target object. In addition, the initial boundary of the target object may be determined based on an initial portion segmented from the image data. That is, the target portion corresponding to the target object may be segmented twice, which can further improve the accuracy of the segmentation. Therefore, the image data of the subject including the target object may be corrected accurately, which in turn can reduce or eliminate artifact(s) in image(s) reconstructed based on the image date of the subject, thereby improving the image quality and the accuracy of the medical diagnosis.

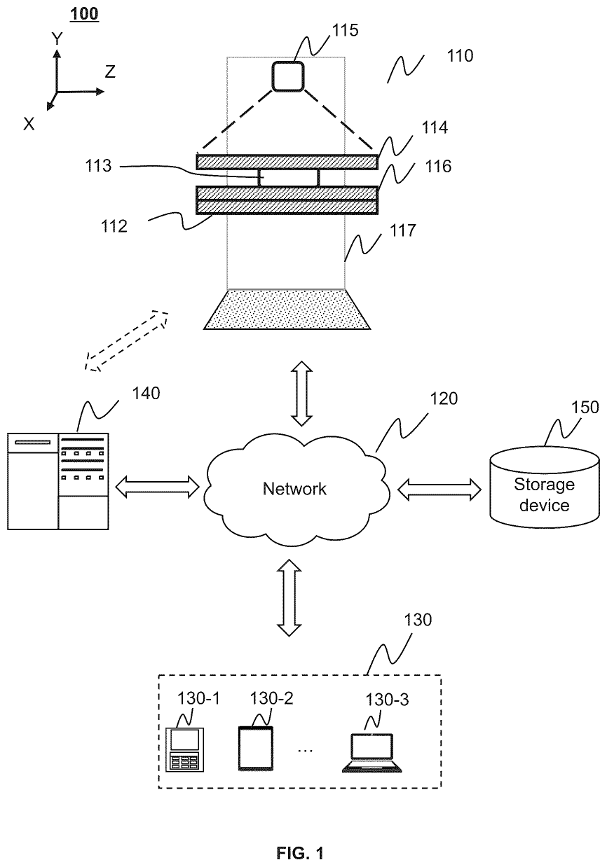

FIG. 1 is a schematic diagram illustrating an exemplary imaging system 100 according to some embodiments of the present disclosure. As shown in FIG. 1, the imaging system 100 may include an imaging device 110, a network 120, one or more terminals 130, a processing device 140, and a storage device 150. In some embodiments, the imaging device 110, the processing device 140, the storage device 150, and/or the terminal(s) 130 may be connected to and/or communicate with each other via a wireless connection (e.g., the network 120), a wired connection, or a combination thereof. The connection between the components in the imaging system 100 may be variable. Merely by way of example, the imaging device 110 may be connected to the processing device 140 through the network 120, as illustrated in FIG. 1. As another example, the imaging device 110 may be connected to the processing device 140 directly. As a further example, the storage device 150 may be connected to the processing device 140 through the network 120, as illustrated in FIG. 1, or connected to the processing device 140 directly.

The imaging device 110 may be configured to acquire image data relating to a subject 113. The imaging device 110 may scan the subject 113 or a portion thereof that is located within its detection region and generate the image data relating to the subject 113 or the portion thereof. The image data relating to at least one part of the subject 113 may include an image (e.g., an image slice, a gradient image, at least one tomographic image, a reconstruction image), projection data, or a combination thereof. In some embodiments, the image data may be two-dimensional (2D) image data, three-dimensional (3D) image data, four-dimensional (4D) image data, or the like, or any combination thereof. The subject 113 may be biological or non-biological. For example, the subject 113 may include a patient, a man-made object, etc. As another example, the subject 113 may include a specific portion, an organ, and/or tissue of the patient. Specifically, the subject 113 may include the head, the neck, a breast, the thorax, the heart, the stomach, a blood vessel, soft tissue, a tumor, or the like, or any combination thereof. In the present disclosure, “object” and “subject” are used interchangeably.

In some embodiments, the imaging device 110 may include a single modality imaging device. For example, the imaging device 110 may include a digital breast tomosynthesis (DBT) device, a computed tomography (CT) device, a cone beam computed tomography (CBCT) device, a digital subtraction angiography (DSA), a positron emission tomography (PET) device, a single-photon emission computed tomography (SPECT) device, a magnetic resonance imaging (MRI) device (also referred to as an MR device, an MR scanner), an ultrasonography scanner, a digital radiography (DR) scanner, or the like, or any combination thereof. In some embodiments, the imaging device 110 may include a multi-modality imaging device. Exemplary multi-modality imaging devices may include a PET-CT device, a PET-MR device, or the like, or any combination thereof.

Merely by way of example, the imaging device 110 may be a DBT device. The DBT device may include a detector 112, a compression component 114, a radiation source 115, a holder 116, and a gantry 117. The gantry 117 may be configured to support one or more components (e.g., the detector 112, the compression component 114, the radiation source 115, the holder 116) of the imaging device 110.

The radiation source 115 may include a high voltage generator (not shown in FIG. 1), a tube (not shown in FIG. 1), and a collimator (not shown in FIG. 1). The high voltage generator may be configured to generate a high voltage for the tube. The tube may be configured to generate and/or emit a radiation beam based on the high voltage. The radiation beam may include a particle ray, a photon ray, or the like, or a combination thereof. In some embodiments, the radiation beam may include a plurality of radiation particles (e.g., neutrons, protons, electrons, μ-mesons, heavy ions), a plurality of radiation photons (e.g., X-ray, a γ-ray, ultraviolet, laser), or the like, or a combination thereof. In some embodiments, the radiation source 115 may include at least one array radiation source. The array radiation source may include a planar array radiation source and/or a linear array radiation source. For example, the radiation source 115 may include one or more linear array radiation sources and/or one or more planar array radiation sources. The collimator may be configured to control an irradiation region (i.e., a radiation field) on the subject 113.

The detector 112 may be configured to detect at least part of the radiation beam. In some embodiments, the detector 112 may be configured opposite to the radiation source 115. For example, the detector 112 may be configured in a direction (substantially) perpendicular to a central axis of the radiation beam emitted by the radiation source 115. As used herein, “substantially” indicates that the deviation is below a threshold (e.g., 5%, 10%, 15%, 20%, 30%, etc.). For instance, a direction being substantially perpendicular to an axis (or another direction) indicates that the deviation of the angle between the direction and the axis (or the other direction) from a right angle is below a threshold. Merely by way of example, a direction being substantially perpendicular to an axis (or another direction) indicates that the angle between the direction and the axis (or the other direction) is in a range of 70°-110°, or 80°-100°, or 85°-95°, etc. As another example, a direction being substantially parallel to an axis (or another direction) indicates that the deviation of the angle between the direction and the axis (or the other direction) from zero degrees is below a threshold. Merely by way of example, a direction being substantially parallel to an axis (or another direction) indicates that the angle between the direction and the axis (or the other direction) is below 30°, or below 25°, or below 20°, or below 15°, or below 10°, or below 5°, etc. In some embodiments, the detector 112 may include a plurality of detecting units. The plurality of detecting units of the detector 112 may be arranged in any suitable manner, for example, a single row, two rows, or another number of rows. The detector 112 may include a scintillation detector (e.g., a cesium iodide detector), a gas detector, a flat panel detector, or the like. In some embodiments, the detector 112 may include a photon counting detector. The photon counting detector may detect an energy of a detected X-ray photon and the count detected X-ray photons. For example, a photomultiplier tube configured on the detector 112 (e.g., the photon counting detector) may be configured to count the detected X-ray photons of different energy ranges.

In some embodiments, the radiation source 115 may rotate around a rotation axis during a scan such that the subject 113 may be scanned (imaged and/or treated) from a plurality of directions. Merely by way of example, the radiation source 115 may be fixedly or movably attached to the gantry 117, and the detector 112 may be fixedly or flexibly attached to the gantry 117 opposite to the radiation source 115. As used herein, a fixed attachment of component A (e.g., the radiation source 115) to component B (e.g., the gantry 117) indicates that the component A does not move relative to the component B when the component A and the component B are properly assembled and used as intended. As used herein, a moveable attachment of component A (e.g., the radiation source 115) to component B (e.g., the gantry 117) indicates that the component A can move relative to the component B when the component A and the component B are properly assembled and used as intended. When the gantry 117 rotates about a gantry rotation axis, the radiation source 115 and the detector 112 attached on the gantry 117 may rotate along with the gantry 117, and the subject 113 may be scanned from a plurality of gantry angles. The gantry rotation axis of the gantry 117 may be in the direction of the X-axis as illustrated in FIG. 1. As used herein, a gantry angle relates to a position of the radiation source 115 with reference to the imaging device 110. For example, a gantry angle may be an angle between a vertical direction and a direction of a beam axis of a radiation beam emitted from the radiation source 115 of the imaging device 110. In some embodiments, a driving device (e.g., a motor, a hydraulic cylinder) may be connected to the gantry 117 to drive the gantry 117 to move (e.g., rotate, translate).

The holder 116 and the compression component 114 may be configured to position the subject 113 (e.g., a breast). In some embodiments, the holder 116 and/or the compression component 114 may be fixedly or movably attached to the gantry 117. The holder 116 may be placed on the top of the detector 112. The subject 113 may be placed on the holder 116. For example, a patient may lay her breast on the holder 116. The compression component 114 may be located between the radiation source 115 and the holder 116. For reasons related both to the immobilizing of the subject 113 (e.g., the breast) and to image quality or intensity of X-rays delivered to the subject 113 (e.g., the breast), By compressing the subject 113 (e.g., the breast) during a scan of the subject 113, the subject 113 may be immobilized during the scan, and the intensity of X-rays delivered to the subject 113 may be increased due to the reduced volume of the subject 113, thereby improving the quality of an image of the subject 113 so acquired. The compression force may be applied through the compression component 114 that compresses the subject 113 (e.g., the breast) on the holder 116. After the breast is compressed by the compression component 114, the shape of the compressed breast may be relatively thin and uniform, and soft tissues in the compressed breast may be separated, which may further improve the quality of an image of the breast so acquired. In some embodiments, the compression component 114 and the holder 116 may not block the radiation beams emitted by the radiation source 115.

During the scan of the subject 113 (e.g., the breast), X-rays emitted by the radiation source 115 may traverse the subject 113 (e.g., the breast). The detector 112 located opposite to the radiation source 115 may detect at least a portion of the X-rays that have traversed the subject 113 (e.g., the breast) and the holder 116. The detector 112 may transform optical signals of the detected X-rays into digital signals, and transmit the digital signals to the processing device 120 for further processing (e.g., generating a breast image).

In some embodiments, the radiation source 115, the detector 112, the holder 116, and/or the compression component 114 may move along a guide rail. For example, the radiation source 115 and/or the detector 112 may move along the guide rail to adjust a distance between the radiation source 115 and the detector 112. As another example, the holder 116 and/or the compression component 114 may move along the guide rail to position the subject 113 (e.g., a breast).

The network 120 may include any suitable network that can facilitate the exchange of information and/or data for the imaging system 100. In some embodiments, one or more components (e.g., the imaging device 110, the terminal 130, the processing device 140, the storage device 150, etc.) of the imaging system 100 may communicate information and/or data with one or more other components of the imaging system 100 via the network 120. For example, the processing device 140 may obtain image data from the imaging device 110 via the network 120. As another example, the processing device 140 may obtain user instructions from the terminal 130 via the network 120. In some embodiments, the network 120 may include one or more network access points.

The terminal(s) 130 may include a mobile device 130-1, a tablet computer 130-2, a laptop computer 130-3, or the like, or any combination thereof. In some embodiments, the mobile device 130-1 may include a smart home device, a wearable device, a mobile device, a virtual reality device, an augmented reality device, or the like, or any combination thereof. In some embodiments, the terminal(s) 130 may be part of the processing device 140.

The processing device 140 may process data and/or information obtained from one or more components (the imaging device 110, the terminal(s) 130, and/or the storage device 150) of the imaging system 100. For example, the processing device 140 may determine, based on image data of the subject 113, an initial boundary of a target object inside the subject 113. A difference between a first parameter value of at least one parameter of the target object and a second parameter value of the at least one parameter of the subject 113 may satisfy a condition. As another example, the processing device 140 may determine, based on the initial boundary of the target object, a closed boundary of the target object. As still another example, the processing device 140 may segment, based on the initial boundary and the closed boundary, a target portion corresponding to the target object from the image data. In some embodiments, the processing device 140 may be a single server or a server group. The server group may be centralized or distributed. In some embodiments, the processing device 140 may be local or remote. In some embodiments, the processing device 140 may be implemented on a cloud platform.

In some embodiments, the processing device 140 may be implemented by a computing device. For example, the computing device may include a processor, a storage, an input/output (I/O), and a communication port. The processor may execute computer instructions (e.g., program codes) and perform functions of the processing device 140 in accordance with the techniques described herein. The computer instructions may include, for example, routines, programs, objects, components, data structures, procedures, modules, and functions, which perform particular functions described herein. In some embodiments, the processing device 140, or a portion of the processing device 140 may be implemented by a portion of the terminal 130.

In some embodiments, the processing device 140 may include multiple processing devices. Thus operations and/or method steps that are performed by one processing device as described in the present disclosure may also be jointly or separately performed by the multiple processing devices. For example, if in the present disclosure the, the imaging system 100 executes both operation A and operation B, it should be understood that operation A and operation B may also be performed by two or more different processing devices jointly or separately (e.g., a first processing device executes operation A and a second processing device executes operation B, or the first and second processing devices jointly execute operations A and B).

The storage device 150 may store data/information obtained from the imaging device 110, the terminal(s) 130, and/or any other component of the imaging system 100. In some embodiments, the storage device 150 may include a mass storage, a removable storage, a volatile read-and-write memory, a read-only memory (ROM), or the like, or any combination thereof. In some embodiments, the storage device 150 may store one or more programs and/or instructions to perform exemplary methods described in the present disclosure.

In some embodiments, the storage device 150 may be connected to the network 120 to communicate with one or more other components in the imaging system 100 (e.g., the processing device 140, the terminal(s) 130, etc.). One or more components in the imaging system 100 may access the data or instructions stored in the storage device 150 via the network 120. In some embodiments, the storage device 150 may be directly connected to or communicate with one or more other components in the imaging system 100 (e.g., the processing device 140, the terminal(s) 130, etc.). In some embodiments, the storage device 150 may be part of the processing device 140.

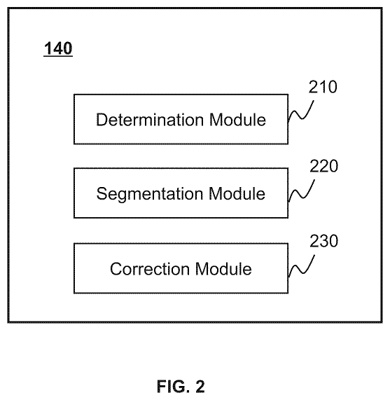

FIG. 2 is a block diagram illustrating an exemplary processing device 140 according to some embodiments of the present disclosure. In some embodiments, the modules illustrated in FIG. 2 may be implemented on the processing device 140. In some embodiments, the processing device 140 may be in communication with a computer-readable storage medium (e.g., the storage device 150 illustrated in FIG. 1) and may execute instructions stored in the computer-readable storage medium. The processing device 140 may include a determination module 210, a segmentation module 220, and a correction module 230.

The determination module 210 may be configured to determine, based on image data of a subject, an initial boundary of a target object inside the subject. A difference between a first parameter value of at least one parameter of the target object and a second parameter value of the at least one parameter of the subject may satisfy a condition. In some embodiments, the determination module 210 may be further configured to determine, based on the initial boundary of the target object, a closed boundary of the target object. For example, the determination module 210 may determine the closed boundary of the target object by using an edge connection algorithm. More descriptions regarding the determination of the initial boundary and closed boundary of the target object may be found elsewhere in the present disclosure. See, e.g., operations 302-304 and relevant descriptions thereof.

The segmentation module 220 may be configured to segment, based on the initial boundary and the closed boundary, a target portion corresponding to the target object from the image data. The target portion may refer to image data of the target object. In some embodiments, the segmentation module 220 may determine a target boundary of the target object based on the initial boundary and the closed boundary, and determine the target portion corresponding to the target object based on the target boundary of the target object. More descriptions regarding the segmentation of the target portion corresponding to the target object may be found elsewhere in the present disclosure. See, e.g., operation 306 and relevant descriptions thereof.

The correction module 230 may be configured to correct the image data of the subject. The target portion may refer to image data of the target object. In some embodiments, the correction module 230 may obtain a corrected target portion by correcting the target portion corresponding to the target object. Accordingly, the correction module 230 may correct the image data of the subject based on the image data and the correct target region. More descriptions regarding the correction of the image data of the subject may be found elsewhere in the present disclosure. See, e.g., operation 308 and relevant descriptions thereof.

The modules in the processing device 140 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof.

It should be noted that the above descriptions of the processing device 140 are provided for the purposes of illustration, and are not intended to limit the scope of the present disclosure. For persons having ordinary skills in the art, various variations and modifications may be conducted under the guidance of the present disclosure. However, those variations and modifications do not depart from the scope of the present disclosure. In some embodiments, the processing device 140 may include one or more other modules. For example, the processing device 140 may include a storage module to store data generated by the modules in the processing device 140. In some embodiments, any two of the modules may be combined as a single module, and any one of the modules may be divided into two or more units. For example, the determination module 210 may include a first determination unit and a second determination unit, wherein the first determination unit may determine the initial boundary of the target object inside the subject based on the image data of the subject, and the second determination unit may determine the closed boundary of the target object based on the initial boundary of the target object.

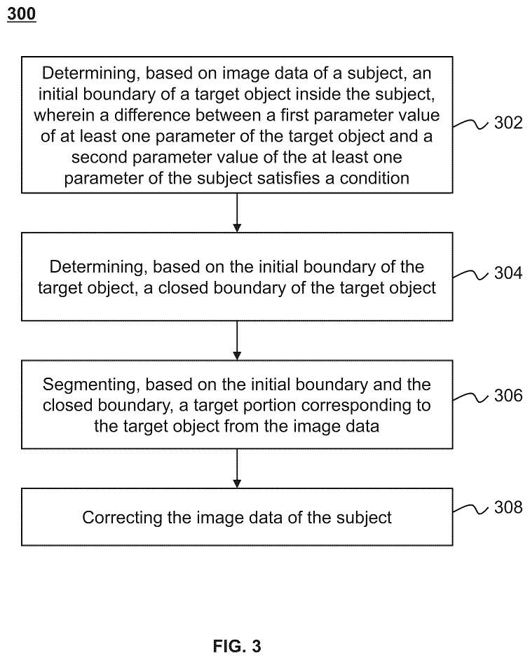

FIG. 3 is a flowchart illustrating an exemplary process for image correction according to some embodiments of the present disclosure. Process 300 may be implemented in the imaging system 100 illustrated in FIG. 1. For example, the process 300 may be stored in the storage device 150 in the form of instructions (e.g., an application), and invoked and/or executed by the processing device 140. The operations of the illustrated process presented below are intended to be illustrative. In some embodiments, the process 300 may be accomplished with one or more additional operations not described, and/or without one or more of the operations discussed. Additionally, the order in which the operations of the process 300 as illustrated in FIG. 3 and described below is not intended to be limiting.

In some embodiments, one or more attenuation objects (e.g., calcifications, metal implants, needles) inside a subject may reduce the accuracy of an image obtained by a medical imaging technique. Merely by way of example, projection data of a subject at different angles may be obtained by using a DBT device to scan the subject based on a sequence of angles, and at least one tomographic image may be obtained by reconstructing the projection data according to a filtered back-projection algorithm. However, attenuation object(s) inside the subject may cause artifact(s) in the tomographic image, which can reduce the accuracy of the at least one tomographic image and/or medical diagnosis.

Conventionally, the attenuation object(s) are segmented from the projection data or the at least one tomographic image according to a threshold segmentation technique, and then the artifact(s) are removed according to an image correction algorithm (e.g., an artifact correction algorithm). However, the threshold in the threshold segmentation technique is usually manually determined or determined according to an index (e.g., a grayscale value), and the quality of the segmentation depends on factors including, e.g., user experience, appropriateness of the index, etc. Due to the complexity of the subject, the attenuation object(s) cannot be precisely segmented according to the threshold segmentation technique, thereby reducing the accuracy of the image correction, and reducing the accuracy of the reconstructed image and/or medical diagnosis. The process 300 may be performed to improve the accuracy of the image segmentation.

In 302, the processing device 140 (e.g., the determination module 210) may determine, based on image data of a subject, an initial boundary of a target object inside the subject. A difference between a first parameter value of at least one parameter of the target object and a second parameter value of the at least one parameter of the subject may satisfy a condition.

The subject may be biological or non-biological. For example, the subject may include a patient, a man-made subject, etc. As another example, the subject may include a specific portion, organ, and/or tissue of the patient as described elsewhere in the present disclosure (e.g., FIG. 1 and the descriptions thereof).

The image data of the subject may include a representation of the subject. In some embodiments, the image data of the subject may include projection data, a gradient image, at least one tomographic image, a reconstruction image, or the like, or any combination thereof, of the subject. For example, the image data of the subject may be projection data of the subject that is obtained by using a DBT device to scan the subject based on a sequence of angles. As another example, the image data of the subject may be at least one tomographic image that is obtained by reconstructing the projection data of the subject according to a filtered back-projection algorithm.

In some embodiments, the processing device 140 may obtain the image data from an imaging device (e.g., the imaging device 110 of the imaging system 100) or a storage device (e.g., the storage device 150, a database, or an external storage device) that stores the image data of the subject. In some embodiments, the processing device 140 may process preliminary image data of the subject to obtain the image data. For example, the processing device 140 may perform one or more operations (e.g., image correction, image resizing, image resampling, image normalization, etc.) on the preliminary image data to obtain the image data of the subject.

The target object may refer to an object that needs to be segmented from the subject. In some embodiments, the target object is different from the subject. As used herein, “different” indicates that the difference between the first parameter value of the at least one parameter of the target object and the second parameter value of the at least one parameter of the subject satisfies the condition. The condition may refer to that the difference between the first parameter value of the at least one parameter of the target object and the second parameter value of the at least one parameter of the subject exceeds or reaches a difference threshold (also referred to as a “first difference threshold”). The first difference threshold may be determined based on a system default setting or set manually by a user (e.g., a doctor, a technician).

In some embodiments, the at least one parameter may include an attenuation parameter, a gradient parameter, a grayscale parameter, or the like, or any combination thereof. The attenuation parameter may indicate an attenuation rate of an object after the object is subjected to radiation ray(s). For example, the attenuation parameter may be an attenuation coefficient or an attenuation constant. The gradient parameter may refer to a speed at which a grayscale value of each pixel (or voxel) in the image data changes. The grayscale parameter may be a grayscale value of each pixel (or voxel) in the image data.

Accordingly, the condition may include that an attenuation difference between the first parameter value of the attenuation parameter of the target object and the second parameter value of the attenuation parameter of the subject exceeds or reaches an attenuation threshold, a gradient difference between the first parameter value of the gradient parameter of the target object and the second parameter value of the gradient parameter of the subject exceeds or reaches a gradient threshold, a grayscale difference between the first parameter value of the grayscale parameter of the target object and the second parameter value of the grayscale parameter of the subject exceeds or reaches a grayscale threshold, or the like, or any combination thereof. The attenuation threshold, the gradient threshold, and/or the grayscale threshold may be determined similar to the determination of the first difference threshold.

In some embodiments, by adjusting the first difference threshold, certain specific characteristics (e.g., object type or object material) of the target object may be determined. For example, the target object may include a calcification, a metal implant, a needle, or the like, or any combination thereof. As another example, the target object may be a certain material (e.g., a tissue) of the subject. For instance, the image data of the subject may be acquired by a medical device that includes multiple sources and/or multiple energy levels, and material separation may be performed to determine the specific material of the subject.

The initial boundary of the target object may refer to a boundary of the target object that needs to be refined. In some embodiments, the initial boundary of the target object may include one or more edges representing the boundary of the target object. An edge may refer to a position where the at least one parameter (e.g., the gradient parameter) changes. For example, an edge may be a position where the difference exceeds or reaches the first difference threshold. In some embodiments, the processing device 140 may determine the initial boundary of the target object from the image data of the subject.

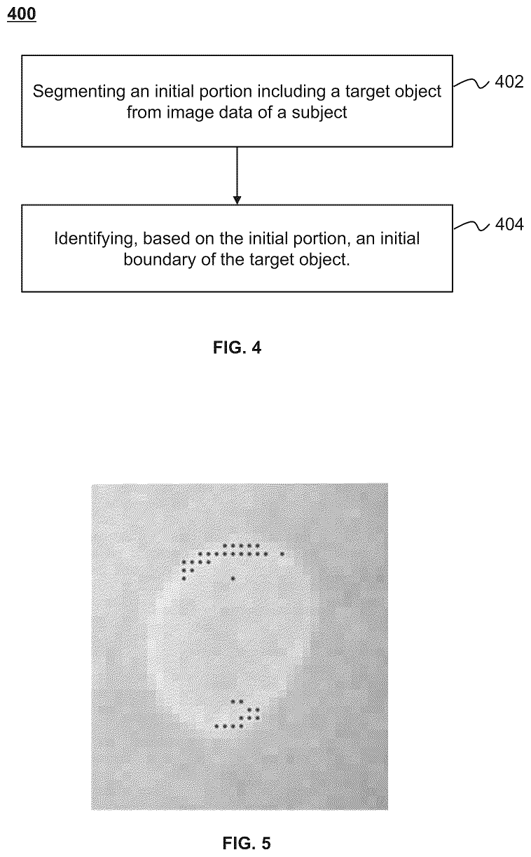

Merely by way of example, the processing device 140 may segment an initial portion including the target object from the image data, and identify the initial boundary of the target object based on the initial portion. More descriptions regarding the determination of the initial boundary of the target object may be found elsewhere in the present disclosure (e.g., FIGS. 4-5 and the descriptions thereof).

In some embodiments, after the initial boundary of the target object is determined, the processing device 140 may perform a filtration operation on the one or more edges. For example, the processing device 140 may filter the one or more edges based on a length of each of the one or more edges. For instance, for each of the one or more edges in the initial boundary, the processing device 140 may determine whether a length of the edge exceeds a length threshold. If the length of the edge exceeds the length threshold, the processing device 140 may retain the edge in the initial boundary. If the length of the edge does not exceed the length threshold, the processing device 140 may remove the edge from the initial boundary. The length threshold may be determined based on a system default setting or set manually by a user, for example, 1 millimeter, 2 millimeters, 3 millimeters, 5 millimeters, etc. By filtering the one or more edges, interfering edge(s) in the initial boundary of the target object may be removed, which can improve the accuracy of the determination of the initial boundary, thereby improving the accuracy of the image segmentation.

In 304, the processing device 140 (e.g., the determination module 210) may determine, based on the initial boundary of the target object, a closed boundary of the target object.

In some embodiments, the processing device 140 may determine the closed boundary of the target object by using an edge connection algorithm. Merely by way of example, the processing device 140 may identify a plurality of points on the initial boundary (i.e., the one or more edges) of the target object. For instance, the processing device 140 may identify each pixel point of the one or more edges of the target object, and designate the pixel points as the plurality of points on the initial boundary of the target object. The processing device 140 may generate a closed region by connecting each two points among the plurality of points. That is, the closed region may be generated by connecting the plurality of points through, for example, an ergodic connection. For instance, a plurality of connection lines may be obtained by connecting each two points among the plurality of points, and the plurality of connection lines may form a closed region. Since the closed region is generated by connecting each two points among the plurality of points, the closed region may be a convex polygon. Further, the processing device 140 may determine, based on the closed region, the closed boundary of the target object. For instance, the processing device 140 may determine a boundary of the closed region using an edge detection algorithm, and designate the boundary of the closed region as the closed boundary of the target object. The edge detection algorithm may include an edge detection operator. More descriptions regarding the edge detection algorithm may be found elsewhere in the present disclosure (e.g., FIG. 4 and the descriptions thereof).

Referring to FIG. 7, FIG. 7 is a schematic diagram illustrating an exemplary closed boundary of a target object according to some embodiments of the present disclosure. As illustrated in FIG. 7, a line 704 is a closed boundary that defines a closed region 702.

In some embodiments, the processing device 140 may traverse the initial boundary (i.e., the one or more edges) of the target object to determine the closed boundary of the target object. For example, each two edges of the one or more edges may be connected to obtain the closed boundary of the target object. As another example, each two adjacent edges of the one or more edges may be connected to obtain the closed boundary of the target object.

In 306, the processing device 140 (e.g., the segmentation module 220) may segment, based on the initial boundary and the closed boundary, a target portion corresponding to the target object from the image data.

The target portion may refer to image data of the target object.

In some embodiments, the processing device 140 may determine, based on the initial boundary and the closed boundary, a target boundary of the target object. The target boundary may refer to a precise boundary of the target object in the image data. As used herein, “precise” indicates that a difference between the target boundary of the target object and an actual boundary of the target object does not exceed a difference threshold (also referred to as a “second difference threshold”). The second difference threshold may be determined based on a system default setting or set manually by a user, for example, 1 millimeter, 2 millimeters, 3 millimeters, 5 millimeters, etc. Referring to FIG. 8, FIG. 8 is a schematic diagram illustrating an exemplary target boundary of a target object according to some embodiments of the present disclosure. As illustrated in FIG. 8, a line 804 is a closed boundary that defines a target object 802.

In some embodiments, the processing device 140 may generate a union of the initial boundary and the closed boundary. Accordingly, the initial boundary and the closed boundary may be marked on the image data. The processing device 140 may determine the target boundary of the target object by processing the union of the initial boundary and the closed boundary. For example, the processing device 140 may process the union of the initial boundary and the closed boundary using an edge tracking algorithm. For instance, the processing device 140 may determine an initial point from the union of the initial boundary and the closed boundary, cause a point on the initial point to travel along the union of the initial boundary and the closed boundary until back to the initial point, and designate a track of the point as the target boundary of the target object. By using the union of the initial boundary and the closed boundary, the target boundary of the target object may be determined automatically and accurately, which in turn can improve the accuracy of the target region of the target object and the segmentation of the target region.

In some embodiments, the processing device 140 may determine the target portion corresponding to the target object based on the target boundary of the target object. For example, the processing device 140 may determine a region defined by the target boundary of the target object, and designate the region as the target portion corresponding to the target object.

In some embodiments, the processing device 140 may segment the target portion corresponding to the target object from the image data. For example, the processing device 140 may segment the target portion using an image identification technique (e.g., an image segmentation technique). Exemplary image segmentation techniques may include a region-based segmentation, an edge-based segmentation, a wavelet transform segmentation, a mathematical morphology segmentation, a machine learning-based segmentation technique (e.g., using a trained segmentation model), a genetic algorithm-based segmentation, or the like, or any combination thereof.

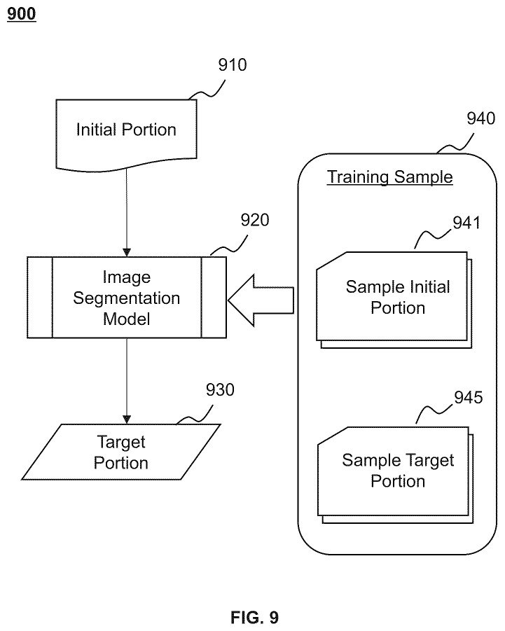

In some embodiments, the processing device 140 may segment the target portion corresponding to the target object by inputting the initial portion into an image segmentation model and obtaining an output. The image segmentation model may include a deep neural network that is configured to segment the target portion based on the initial portion. In some embodiments, the image segmentation model may be trained based on a plurality of training samples. A training sample may include a sample initial portion of a sample object and a sample target portion of the sample object. More descriptions regarding the determination of the target portion using the image segmentation prediction model may be found elsewhere in the present disclosure (e.g., FIG. 9 and the descriptions thereof).

In 308, the processing device 140 (e.g., the correction module 230) may correct the image data of the subject.

In some embodiments, the processing device 140 may obtain a corrected target portion by correcting the target portion corresponding to the target object. For example, the processing device 140 may automatically correct the target portion using an image correction algorithm. In some embodiments, the image correction algorithm may be any feasible correction algorithm, for example, a filtered back-projection reconstruction algorithm, a registration algorithm, a noise processing algorithm, a contrast processing algorithm, an artifact removal algorithm, etc., which are not limited in the present disclosure. In some embodiments, the image correction algorithm may be stored in software form in a storage device (e.g., the storage device 150).

In some embodiments, the processing device 140 may correct the image data of the subject based on the image data and the correct target region. For example, the processing device 140 may correct the image data of the subject by using the corrected target portion to replace the target portion. As another example, the processing device 140 may obtain remaining image data by deleting the target portion corresponding to the target object from the image data, and may correct the image data of the subject based on the remaining image data and the correct target region. For instance, the image data of the subject may be corrected by combining the remaining image data and the correct target region.

In some embodiments, the processing device 140 may correct the image data of the subject by reconstructing the target portion of the target object. For example, the target portion corresponding to the target object may be reconstructed to obtain a first reconstruction portion. After the target portion corresponding to the target object is segmented from the image data, segmented portion in the image data may be filled with image data of a vicinity of the target region to obtain image data without the target portion. The image data without the target portion may be reconstructed to obtain a second reconstruction portion. Position information of the target region relative to the first reconstruction portion may be determined according to a geometric relationship between the target region and the first reconstruction portion, and the target portion may be segmented from the first reconstruction portion based on the determined position information. Further, the target portion may be fused into the second reconstruction portion to obtain a target reconstruction portion without artifact(s).

In some embodiments, a positional model may be established to represent the position information. For example, after the target region is determined, a value of each pixel of the target region in the image data may be designated as “1,” and a value of each pixel of other regions in the image data may be designated as “0,” so as to establish a “0-1” model (i.e., the positional model). By constructing the “0-1” model, the position information of the target region relative to the first reconstruction portion may be determined. By using the positional model, the position information may be determined accurately and clearly.

According to some embodiments of the present disclosure, the target portion corresponding to the target object from the image data may be segmented based on the initial boundary and the closed boundary, which can improve the accuracy of the segmentation of the target object. In addition, the image data of the subject may be corrected accurately, which in turn can improve the image quality and the accuracy of the medical diagnosis.

It should be noted that the description of the process 300 is provided for the purposes of illustration, and is not intended to limit the scope of the present disclosure. For persons having ordinary skills in the art, various variations and modifications may be conducted under the teaching of the present disclosure. For example, operation 308 may be removed. As another example, an operation for obtaining the image data or determining the initial portion may be added before the operation 302. However, those variations and modifications may not depart from the protection of the present disclosure.

FIG. 4 is a flowchart illustrating an exemplary process 400 for determining an initial boundary of a target object inside a subject according to some embodiments of the present disclosure. In some embodiments, the process 400 may be performed to achieve at least part of operation 302 as described in connection with FIG. 3.

In 402, the processing device 140 (e.g., the determination module 210) may segment an initial portion including a target object from image data of a subject.

The initial portion may refer to a portion that needs to be finely segmented.

In some embodiments, the processing device 140 may segment the initial portion including the target object inside the subject using a rough segmentation algorithm. Exemplary rough segmentation algorithms may include a region-based segmentation algorithm, a threshold-based segmentation algorithm, a wavelet transform-based segmentation algorithm, a neural network-based segmentation algorithm, or the like, or any combination thereof. For example, the processing device 140 may determine the initial boundary of the target object based on a rough segmentation algorithm. As another example, if the image data of the subject includes a tomographic image of the subject, the processing device 140 may segment the initial portion from the tomographic image using a rough segmentation algorithm. As still another example, if the image data of the subject includes projection data of the subject, the processing device 140 may reconstruct the projection data based on a back-projection algorithm to obtain tomographic image(s) of the subject, and then segment the initial portion from the tomographic image(s) using a rough segmentation algorithm. Exemplary back-projection algorithms may include a direct back-projection algorithm, a filtered back-projection (FBP) algorithm, etc. Further, the processing device 140 may determine the initial portion in the projection data based on a corresponding relationship (e.g., a reconstruction relationship, a geometrical relationship) between the projection data and the tomographic image(s).

In some embodiments, the processing device 140 may segment the initial portion including the target object inside the subject based on a preset threshold. The preset threshold may refer to a minimum value that a pixel in the image data is a portion of the target object. For example, if the image data of the subject includes a gradient image, the processing device 140 may segment the initial portion based on the preset threshold (e.g., a gradient threshold). For instance, each pixel of the gradient image may correspond to a gradient value. For each pixel of the gradient image, the processing device 140 may determine whether the gradient value of the pixel exceeds the gradient value. If the gradient value of the pixel exceeds the gradient value, the processing device 140 may determine the pixel as a portion of the target object. If the gradient value of the pixel does not exceed the gradient value, the processing device 140 may determine that the pixel isn't a portion of the target object. In some embodiments, the gradient threshold may be determined based on a system default setting or set manually by a user. Referring to FIG. 5, which is a schematic diagram illustrating an exemplary initial portion in a gradient image according to some embodiments of the present disclosure, black dots are pixels whose gradient values exceed the gradient value, and the processing device 140 may determine pixels corresponding to the black dots as the target object.

In some embodiments, the gradient image may be determined based on projection data of the subject. For example, the processing device 140 may process the projection data through a gradient algorithm (e.g., a gradient projection algorithm) to obtain the gradient image. That is, the processing device 140 may convert the projection data into the gradient image according to the gradient projection algorithm. In some embodiments, the projection data may include grayscale values, and the gradient value of the pixel may be a gradient value generated based on the grayscale value corresponding to the pixel.

In some embodiments, the gradient image may be determined based on at least one tomographic image of the subject. For example, the processing device 140 may process the at least one tomographic image through a gradient algorithm to obtain the gradient image. That is, the processing device 140 may convert the at least one tomographic image into the gradient image according to the gradient algorithm. As another example, the processing device 140 may determine, based on the at least one tomographic image, a maximal intensity projection image. For instance, ray(s) are emitted from a preset direction to the at least one tomographic image, and projected onto a two-dimensional plane. A maximum value of each pixel in the at least one tomographic image passed by the ray(s) may be a pixel value of an image on the two-dimensional plane. The processing device 140 may determine the image on the two-dimensional plane as the maximal intensity projection image. The preset direction may be determined based on a system default setting or set manually by a user. Further, the maximal intensity projection image may be processed through a gradient algorithm to obtain the gradient image. For example, the processing device 140 may process the maximal intensity projection image along a filtered direction of the FBP algorithm.

In some embodiments, the processing device 140 may segment the initial portion including the target object inside the subject by reconstructing the image data. For example, if the image data of the subject is the projection data, the processing device 140 may reconstruct the projection data through a reconstruction algorithm to obtain a reconstruction body. Exemplary reconstruction algorithms may include an analytic reconstruction algorithm, an iterative reconstruction algorithm, a Fourier-based reconstruction algorithm, etc. Exemplary analytic reconstruction algorithms may include a filter back projection (FBP) algorithm, a back-projection filter (BFP) algorithm, a ρ-filtered layer gram, or the like, or any combination thereof. Exemplary iterative reconstruction algorithms may include a maximum likelihood expectation maximization (ML-EM), an ordered subset expectation maximization (OSEM), a row-action maximum likelihood algorithm (RAMLA), a dynamic row-action maximum likelihood algorithm (DRAMA), or the like, or any combination thereof. Exemplary Fourier-based reconstruction algorithm may include a classical direct Fourier algorithm, a non-uniform fast Fourier transform (NUFFT) algorithm, or the like, or any combination thereof. Since the image data of the subject includes the target object, the reconstruction body may include the target object. The processing device 140 may determine a preliminary initial region of the target object in the reconstructed body based on a region growth algorithm. For instance, the processing device 140 may determine a seed region (e.g., one or more pixels) in the reconstructed body. The seed region may be within the preliminary initial region of the target object in the reconstructed body. Accordingly, whether each pixel in a vicinity of the preliminary initial region is within the preliminary initial region may be determined. If the pixel in the vicinity of the preliminary initial region is within the preliminary initial region, the pixel may be added into the preliminary initial region. After pixels in the reconstructed body are determined, a target initial region in the reconstructed body may be determined. Further, the processing device 140 may determine the initial portion in the projection data based on a corresponding relationship (e.g., a reconstruction relationship, a geometrical relationship) between the projection data and the reconstructed body and the target initial region in the reconstructed body.

In some embodiments, the processing device 140 may segment the initial portion including the target object inside the subject by performing material separation on the image data of the subject. The material separation may refer to an operation that determines information of separate materials from the image data. For example, each voxel (or pixel) of the image data may be assumed to correspond to two materials (e.g., water and iodine) in different proportions, wherein the proportions of the two materials within each voxel may be determined based on attenuation coefficients of the two materials at different energy levels. Therefore, the processing device 140 may generate material-specific images (e.g., an iodine image and a water image) based on the proportions of the two materials within each voxel. In some embodiments, the material separation may be performed based on a two-material decomposition algorithm, a three-material decomposition algorithm, a multi-material decomposition (MMD) algorithm, etc. Exemplary material-specific images may include an iodine image, a water image, a calcium image, or the like, or any combination thereof. In an iodine image, signals of the iodine may be strong, while signals of the water may be invisible. Alternatively, in a water image, signals of the water may be strong, while signals of the iodine may be invisible. Further, the processing device 140 may determine and segment the initial portion including the target object inside the subject based on the material-specific image.

In 404, the processing device 140 (e.g., the determination module 210) may identify, based on the initial portion, an initial boundary of the target object.

In some embodiments, the processing device 140 may identify an initial boundary of the target object using an edge detection algorithm. The edge detection algorithm may include an edge detection operator. Exemplary edge detection operators may include a Roberts operator, a Prewitt operator, a Sobel operator, a Scharr operator, a Kirsch operator, a Robinson operator, a Laplacian operator, a Laplacian of Gaussian (LOG) operator, a Canny operator, or the like, or any combination thereof. For example, after an initial portion including a target object is segmented from image data of a subject, an edge detection operator of an edge detection algorithm may be used to convolve the segmented initial portion, and then an initial boundary of the target object may be identified. For instance, the initial boundary of the target object may be identified based on a grayscale threshold. Each pixel of the initial boundary may correspond to a grayscale value. For each pixel of the initial boundary, the processing device 140 may determine whether the grayscale value of the pixel exceeds the grayscale threshold. If the grayscale value of the pixel exceeds the grayscale threshold, the processing device 140 may determine the pixel as a portion of the initial boundary. If the grayscale value of the pixel does not exceed the grayscale threshold, the processing device 140 may determine that the pixel isn't a portion of the initial boundary. In some embodiments, the grayscale threshold may be determined based on a system default setting or set manually by a user. As another example, a plurality of edge detection operators may be used to convolve the segmented initial portion together, and then an initial boundary of the target object may be identified. As still another example, a plurality of edge detection operators may be used to convolve the segmented initial portion respectively, and then a plurality of preliminary initial boundaries of the target object may be identified. The processing device 140 may determine an initial boundary of the target object based on the plurality of preliminary initial boundaries. For instance, the processing device 140 may filter the plurality of preliminary initial boundaries based on a filtration operation described in operation 302. By using the plurality of edge detection operators to process the initial portion, the accuracy of the identification of the initial boundary may be improved.

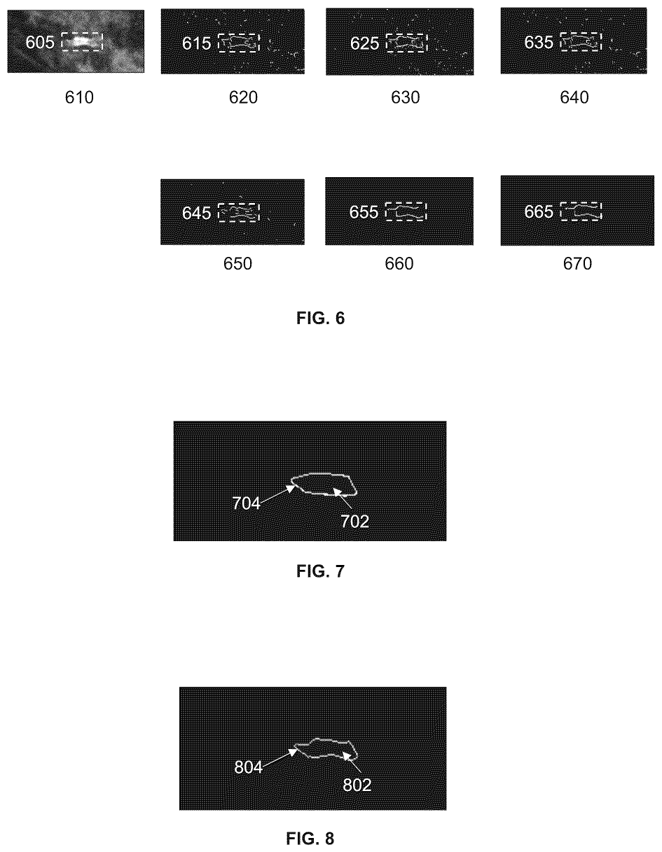

Referring to FIG. 6, which is a schematic diagram illustrating an exemplary process for identifying an initial boundary of a target object according to some embodiments of the present disclosure, an image 610 may be an initial portion of a target object, and a white portion in box 605 may be the target object. Accordingly, an image 620 may be the initial portion processed through a Sobel operator, and white lines in box 615 may be the initial boundary of the target object corresponding to the Sobel operator. An image 630 may be the initial portion processed through a Roberts operator, and white lines in box 625 may be the initial boundary of the target object corresponding to the Roberts operator. An image 640 may be the initial portion processed through a Prewitt operator, and white lines in box 635 may be the initial boundary of the target object corresponding to the Prewitt operator. An image 650 may be the initial portion processed through a LOG operator, and white lines in box 645 may be the initial boundary of the target object corresponding to the LOG operator. An image 660 may be the initial portion processed through a Canny operator, and white lines in box 655 may be the initial boundary of the target object corresponding to the Canny operator. An image 670 may be the initial portion processed through the LOG operator and the Canny operator, and white lines in box 665 may be the initial boundary of the target object corresponding to the LOG operator and the Canny operator. In some embodiments, the white lines in the box 665 may be determined as the initial boundary of the target object. Further, the white lines in the box 665 may be used to determine a closed boundary (e.g., the line 704 in FIG. 7) of the target object according to operation 304, and the white lines in the box 665 and the closed boundary may be used to determine a target boundary (e.g., the line 804 in FIG. 8) of the target object according to operation 306.

It should be noted that the description of the process 400 is provided for the purposes of illustration, and is not intended to limit the scope of the present disclosure. For persons having ordinary skills in the art, various variations and modifications may be conducted under the teaching of the present disclosure. For example, operation 402 may be removed. That is, the processing device 140 may identify the initial boundary of the target object based on the image data of the subject. For instance, the processing device 140 may identify, based on the image data of the subject, the initial boundary of the target object using an edge detection algorithm. However, those variations and modifications may not depart from the protection of the present disclosure.

FIG. 9 is a schematic diagram illustrating an exemplary process for determining a target portion according to some embodiments of the present disclosure.

As shown in FIG. 9, in some embodiments, an initial portion 910 corresponding to a target object may be input into an image segmentation model 920, and the image segmentation model 920 may output a target portion 930.

In some embodiments, the image segmentation model 920 may include a convolutional neural network (CNN), a deep neural network (DNN), a recurrent neural network (RNN), or the like, or any combination thereof.

In some embodiments, the image segmentation model 920 may be obtained by training an initial model based on a plurality of training samples 940. In some embodiments, each of the plurality of training samples 940 may include a sample initial portion 941 of a sample object inside a sample subject as an input of the initial image segmentation model, and a sample target portion 945 as a label.

The obtaining of the sample initial portion 941 may be similar to the obtaining of the initial portion described in operations 402-404. In some embodiments, the sample target portion 945 may be obtained according to the process 300 illustrated in FIG. 3. In some embodiments, the processing device 140 may obtain the plurality of training samples by retrieving (e.g., through a data interface) a database or a storage device.

During the training of the initial model, the plurality of training samples may be input to the initial model, and parameter(s) of the initial model may be updated through one or more iterations. For example, the processing device 140 may input the sample initial portion 941 of each training sample into the initial model, and obtain a prediction result. The processing device 140 may determine a loss function based on the prediction result and the label (i.e., the corresponding sample target portion 945) of each training sample. The loss function may be associated with a difference between the prediction result and the label. The processing device 140 may adjust the parameter(s) of the initial model based on the loss function to reduce the difference between the prediction result and the label, for example, by continuously adjusting the parameter(s) of the initial model to reduce or minimize the loss function.

In some embodiments, the loss function may be a perceptual loss function, a squared loss function, a logistic regression loss function, etc.

In some embodiments, the image segmentation model 920 may also be obtained according to other training manners. For example, the image segmentation model 920 may be obtained based on an initial learning rate (e.g., 0.1) and/or an attenuation strategy using the plurality of training samples.

According to some embodiments, the target portion corresponding to the target object may be determined using the image segmentation model, which can improve the efficiency of the determination of the target portion, thereby improving the efficiency of the image segmentation.

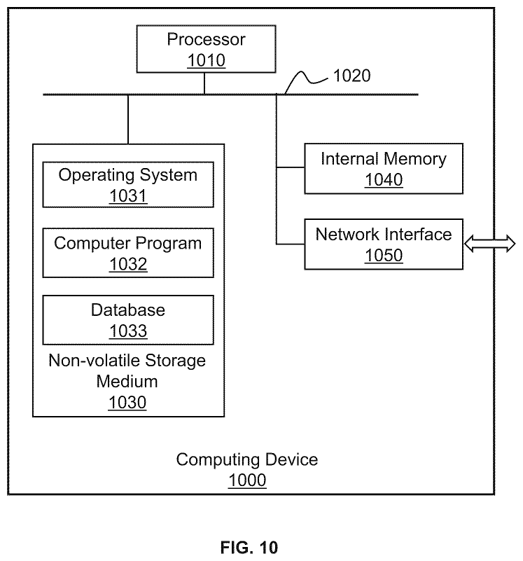

FIG. 10 is a diagram illustrating an exemplary computing device according to some embodiments of the present disclosure.

In some embodiments, a computing device 1000 is provided. The computing device 1000 may be a server, and its internal components may be shown in FIG. 10. The computing device 1000 may include a processor 1010, a storage, a network interface 1050, and a database 1033 connected through a system bus 1020. The processor 1010 of the computing device 1000 may be configured to provide computing and/or control capabilities. The storage of the computing device 1000 may include a non-volatile storage medium 1030 and an internal memory 1040. The non-volatile storage medium 1030 may store an operating system 1031, computer program(s) 1032, and the database 1033. The internal memory 1040 may provide an environment for the operation of the operating system 1031 and the computer program(s) 1032 of the non-volatile storage medium 1030. The database 1033 of the computing device 1000 may be configured to store data associated with image segmentation (e.g., the image data of the subject, the image segmentation model, the first difference threshold, the second difference threshold, etc.). The network interface 1050 of the computing device 1000 may be configured to communicate with an external terminal through a network connection. The computer program(s) 1032 may be executed by the processor 1010 to implement the time correction.

It will be understood by those skilled in the art that the structure shown in FIG. 10 is merely a block diagram of a part of the structure related to the present disclosure, and does not constitute a limitation on the computing device to which the present disclosure scheme is applied. The computing device 1000 may include more or fewer components than those shown in the figures, or some components may be combined, or have different component arrangements.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for image segmentation, implemented on a computing device having at least one processor and at least one storage device, the method comprising:
determining, based on image data of a subject, an initial boundary of a target object inside the subject, wherein a difference between a first parameter value of at least one parameter of the target object and a second parameter value of the at least one parameter of the subject satisfies a condition;
determining, based on the initial boundary of the target object, a closed boundary of the target object; and
segmenting, based on the initial boundary and the closed boundary, a target portion corresponding to the target object from the image data.

2. The method of claim 1, wherein the determining, based on the initial boundary of the target object, a closed boundary of the target object includes:
identifying a plurality of points on the initial boundary of the target object;
generating a closed region by connecting each two points among the plurality of points; and
determining, based on the closed region, the closed boundary of the target object.

3. The method of claim 1, wherein the segmenting, based on the initial boundary and the closed boundary, a target portion corresponding to the target object from the image data includes:
determining, based on the initial boundary and the closed boundary, a target boundary of the target object; and
segmenting, based on the target boundary, the target portion corresponding to the target region from the image data.

4. The method of claim 3, wherein the determining, based on the initial boundary and the closed boundary, a target boundary of the target object includes:
generating a union of the initial boundary and the closed boundary; and
determining the target boundary of the target object by processing the union of the initial boundary and the closed boundary.

5. The method of claim 1, wherein the at least one parameter includes at least one of an attenuation parameter or a gradient parameter.

6. The method of claim 1, wherein the determining, based on image data of a subject, an initial boundary of a target object inside the subject includes:
segmenting an initial portion including the target object from the image data; and
identifying, based on the initial portion, the initial boundary of the target object.

7. The method of claim 1, wherein the image data includes at least one of projection data, a gradient image, at least one tomographic image, or a reconstruction image.

8. The method of claim 1, further comprising:
correcting the image data of the subject by:
obtaining a corrected target portion by correcting the target portion corresponding to the target object; and
correcting the image data of the subject based on the image data and the correct target region.

9. The method of claim 8, wherein the correcting the image data of the subject based on the image data and the correct target region includes:
obtaining remaining image data by deleting the target portion corresponding to the target object from the image data; and
correcting the image data of the subject based on the remaining image data and the correct target region.

10. A method for image segmentation, implemented on a computing device having at least one processor and at least one storage device, the method comprising:
obtaining image data of a subject, the subject including a target object, wherein a difference between a first parameter value of at least one parameter of the target object and a second parameter value of the at least one parameter of the subject satisfies a condition;
determining, based on the image data, an initial portion including the target object; and
segmenting a target portion corresponding to the target object from the initial portion.

11. The method of claim 10, wherein the segmenting a target portion corresponding to the target object from the initial portion includes:
obtaining an image segmentation model;
determining the target portion corresponding to the target object by inputting the initial portion into the image segmentation model.

12. The method of claim 10, wherein the segmenting a target portion corresponding to the target object from the initial portion includes:
determining, based on the initial portion, an initial boundary of the target object inside the subject;
determining, based on the initial boundary of the target object, a closed boundary of the target object; and
segmenting, based on the initial boundary and the closed boundary, the target portion corresponding to the target object from the initial portion.

13. The method of claim 12, wherein the determining, based on the initial boundary of the target object, a closed boundary of the target object includes:
identifying a plurality of points on the initial boundary of the target object;
generating a closed region by connecting each two points among the plurality of points; and
determining, based on the closed region, the closed boundary of the target object.

14. The method of claim 12, wherein the segmenting, based on the initial boundary and the closed boundary, the target portion corresponding to the target object from the initial portion includes:
determining, based on the initial boundary and the closed boundary, a target boundary of the target object; and
segmenting, based on the target boundary, the target portion corresponding to the target region from the initial portion.

15. The method of claim 14, wherein the determining, based on the initial boundary and the closed boundary, a target boundary of the target object includes:
generating a union of the initial boundary and the closed boundary; and
determining the target boundary of the target object by processing the union of the initial boundary and the closed boundary.

16. The method of claim 10, wherein the at least one parameter includes at least one of an attenuation parameter or a gradient parameter.

17. The method of claim 10, wherein the determining, based on the initial portion, an initial boundary of the target object inside the subject includes:
segmenting the initial portion including the target object from the image data; and
identifying, based on the initial portion, the initial boundary of the target object.

18. The method of claim 10, further comprising:
correcting the image data of the subject by:
obtaining a corrected target portion by correcting the target portion corresponding to the target object; and
correcting the image data of the subject based on the image data and the correct target region.

19. The method of claim 18, wherein the correcting the image data of the subject based on the image data and the correct target region includes:
obtaining remaining image data by deleting the target portion corresponding to the target object from the image data; and
correcting the image data of the subject based on the remaining image data and the correct target region.

20. A method for image correction, implemented on a computing device having at least one processor and at least one storage device, the method comprising:
obtaining image data of a subject, the subject including a target object, wherein a difference between a first parameter value of at least one parameter of the target object and a second parameter value of the at least one parameter of the subject satisfies a condition;
determining, based on the image data, an initial portion including the target object;
segmenting a target portion corresponding to the target object from the initial portion; and
correcting the image data of the subject based on the target portion corresponding to the target object.
